(19) United States
(12) Patent Application Publication
(10) Pub. No.: US 2017/0052321 A1
(43) Pub. Date: Feb. 23, 2017

(54) FUSED EXPANDED BEAM CONNECTOR

(71) Applicant: CommScope, Inc. of North Carolina, Hickory, NC (US)

(72) Inventors: Brian K. BUSHNELL, Wylie, TX (US); Earl R. Parsons, Allen, TX (US); Joseph C. Livingston, McKinney, TX (US)

(73) Assignee: CommScope, Inc. of North Carolina

(21) Appl. No.: 15/242,479

(22) Filed: Aug. 19, 2016

Related U.S. Application Data
(60) Provisional application No. 62/208,730, filed on Aug. 23, 2015.

(51) Int. Cl. G02B 6/32; G02B 6/25; G02B 6/38

(52) U.S. Cl. CPC G02B 6/32; G02B 6/3885; G02B 6/3882; G02B 6/3865; G02B 6/25

(57) ABSTRACT

A fiber optic connector includes a ferrule for holding a plurality of optical fibers. The ferrule has a first end and a second end. A plurality of optical fibers enter at the first end of the ferrule and extend to the second end of the ferrule, wherein ends of the plurality of optical fibers are approximately flush or slightly protruding along a mating face defining the second end of the ferrule. A lens frame has a front surface and a back surface, wherein the back surface abuts the second end of the ferrule. Lenses are formed in the lens frame, wherein each lens of the plurality of lenses overlies a flush or protruding end of one of the plurality of optical fibers. Optionally, a film, mounted to a frame, is disposed between the ends of the plurality of optical fibers and the plurality of lenses.

This application claims the benefit of U.S. Provisional Application No. 62/208,730, filed Aug. 23, 2015, which is herein incorporated by reference.

### BACKGROUND OF THE INVENTION

1. Field of the Invention

The present invention relates to an expanded beam multi-fiber connector. More particularly, the present invention relates to a device for attachment to an MT-type ferrule to create an expanded beam multi-fiber connector, and method of forming the expanded beam multi-fiber connector.

2. Description of the Related Art

Fiber optic cables that contain a plurality of optical fibers are routinely employed in a wide variety of applications. Typically, such cables include a plurality of optical fibers, one or more strength members or yarns such as aramid fibers, and a cable jacket that encloses and protects the optical fibers and the strength members. The optical fibers may be non-buffered or buffered optical fibers, and the individual optical fibers may or may not be enclosed in protective tubing such as, for example, furcation tubing. Both loose tube and ribbonized fiber optic cables are known in the art, as well as cables that include both loose tube and ribbonized sections.

Fiber optic cables may be “connectorized” either at the time of manufacture or later in the field to allow the fiber optic cable to be connected to another connectorized fiber optic cable or to connectors on fiber optic equipment. Fiber optic cables that include a connector on at least one end are often referred to as fiber optic “patch cords” or “jumper cables.” Conventional multi-fiber fiber optic connectors typically include, among other things, a housing, a ferrule that is at least partly mounted in the housing that precisely aligns the optical fibers, a ferrule boot and a spring.

A multi-fiber fiber optic cable may be terminated by cutting away and/or peeling back end portions of the cable jacketing material and the strength yarns. The spring and the ferrule boot may be slid onto the exposed ends of the optical fibers. The exposed ends of the optical fibers are then aligned in the proper order and held in place by any appropriate means such as, for example, tape, a clamping tool, a ribbonizing fixture and/or adhesives. Any adhesives may be removed from an end section of the ribbonized bundle of optical fibers. Epoxy is applied to the fiber holes in the ferrule and the optical fibers may then be slid through the fiber holes. Additional epoxy is then injected into a cavity of the ferrule through a window to lock the optical fibers in place within the ferrule. Portions of the optical fibers that extend forwardly out of the ferrule holes may then be cut away (“cleaved”), and the bare ends of the optical fibers may be “air polished,” which refers to a freehand operation that quickly removes excess fiber protruding from the end of the connector. Next, the bare ends of the optical fibers may be mechanically polished through a multi-step polishing procedure that uses a polishing film such as an aluminum oxide film. The grit size on the film may be successively reduced to finer and finer sizes during this multi-step process. In the final steps of the mechanical polishing procedure, the front face of the ferrule may also be polished to an extent. The ferrule may be a polymeric material such as a glass filled polymer. Typically, the ferrule is ground away more quickly by the mechanical polishing than the optical fibers, and hence the ends of the optical fibers typically protrude a short distance forwardly from a front face of the ferrule. Ideally, each optical fiber will protrude the exact same distance forwardly from the ferrule so that when the fiber optic connector is mated with another fiber optic connector, the aligned optical fibers in each connector will directly contact each other to provide low-loss optical connections between the mated optical fibers.

Unfortunately, it may be difficult to ensure that all of the optical fibers extend the exact same distance from the front face of the ferrule. This is particularly true with fiber optic cable terminations that include a large number of optical fibers (e.g., eight, twelve or more optical fibers) such as, an MTP/MPO (multi-fiber termination push-on/Multi-fiber Push On) connectors or MT-RJ connectors. Such connectors are known in the background art, such as in U.S. Pat. No. 6,880,980, which is incorporated herein by reference. Such connectors present one or more arrays of polished fiber ends at a front face of the MTP/MPO or MT-RJ connector (collectively referred to as an “MPO” connector herein), as shown in the figures of U.S. Pat. No. 6,880,980.

If the optical fibers do not all protrude the exact same distance from the front face of the ferrule, then when the connectorized fiber optic cable is mated with, for example, another connectorized fiber optic cable, air gaps may exist between the “shorter” optical fibers of the first connectorized fiber optic cable and the mating optical fibers in the second connectorized fiber optic cable.

These air gaps may increase the insertion loss of the connection between these mating optical fibers because (1) the change in refractive index caused by the air gap may result in Fresnel reflection losses and (2) the lack of any waveguide in the air gap may result in coupling losses due to divergence of the optical signal at the air gap. Typical manufacturing specifications call for all of the optical fibers in a multi-fiber fiber optic connector to have less than a 0.5 micron variation in the extent by which the optical fibers extend from the front face of the ferrule in order to reduce the presence and size (length) of any air gaps. This may help reduce optical losses when two connectorized fiber optic cables are mated together.

To further reduce such losses, the use of index-matched films have been proposed, whereby a thin compliant film having an appropriate refractive index is adhered to the ends of the optical fibers of one of the connectors. This compliant index-matching film is thus interposed between the optical fibers of two mated connectorized fiber optic cables, and may serve to fill in any gaps between mating optical fibers of the two connectorized cables. As the index-matching film may be compliant, the longer optical fibers may press into the film and reduce the thickness thereof. As a result, the shorter optical fibers may directly contact the film, and hence the film may eliminate the air gaps. The index-matching film may thus reduce the Fresnel reflection losses.

The use of such index-matching films has been proposed for many years, and examples of fiber optic connectors and/or adapters including such index matching films are disclosed in U.S. Pat. Nos. 4,991,929; 6,623,174; and 8,611,712 and in US Patent Publication Nos. 2007/0086707, 2010/0124394 and 2013/0216189. Despite the apparent interest in the use of such index-matching films, connectors including such films have not been widely adopted in practice.

Expanded beam multi-fiber connectors are also known in the art, as from Applicants prior U.S. Pat. No. 8,393,804 and Applicant's published US Patent Application 2015/0104135, both of which are incorporated herein by reference.

Applicants' prior U.S. Pat. No. 8,393,804 demonstrated an advantage over the array type connectors having polished fiber ends. As shown in FIGS. 13 and 14 of U.S. Pat. No. 8,393,804, a multi-fiber connector 81 may include pins 83 or alignment holes 85 to assist in mating the multi-fiber connector 81 into an adapter or port. A lens 91 (such as one of spherical lenses 91-1 through 91-8 formed of sapphire) is affixed at the end of each V-groove 87 (such as one of V-grooves 87-1 through 87-8) for each fiber 89 (such as one of fibers 89-1 through 89-8) of the multi-fiber connector 81. Hence, the connector 81 is converted into an expanded beam connector, which has several advantages, as described in more detail in U.S. Pat. No. 8,393,804.

US Published Patent Application 2009/0154884, which is herein incorporated by reference, shows a modified expanded beam MT ferrule. In the device depicted in FIGS. 15-17 of US Published Patent Application 2009/0154884, a frame 102 has a front or mating face 103. Guide pin holes 104 are formed in the front face 103. V-grooves 109 holding optical fibers 134 are located at a rear portion of the frame 102. The frame 102 has lenses 106 at the ends of the V-grooves 109. The lenses 106 are integrally molded with the frame 102 out of a common material, like a polycarbonate or Ultem (See paragraph 0015, lines 6-8 of US Published Patent Application 2009/0154884).

Therefore, US Published Patent Application 2009/0154884 offers an advantage over U.S. Pat. No. 8,393,804 in that the lenses 106 are not separate elements which must be assembled/adhered to the V-grooves 109, but are rather integrally molded features of the frame 102 adjacent to the V-grooves 109. Because the lenses 106 are integrally molded, the frame 102 requires “precision machining and tooling” (See paragraph 0016, lines 13-14 of US Published Patent Application 2009/0154884). The other portions of the connector do not require precision machining or tooling, like the housing 112 and boot 124. The housing 112 can be formed of glass filled thermo plastics, such as liquid crystal polymer. The boot 124 may be formed of thermo plastic rubber, such as a polypropylene vulcanization elastomer.

Additional related art may be found in the following U.S. patent and US Published Applications, each of which is herein incorporated by reference: U.S. Pat. No. 7,898,736; 2001/0055446; 2002/0118925; 2004/0017984; 2006/0245694; 2009/0324175; 2010/0329612; 2012/0014645; 2012/0020618; 2012/0155807; and 2013/0251315 and PCT publication WO 2012/106510.

### SUMMARY OF THE INVENTION

The Applicant has appreciated drawbacks in the above-described expanded beam MPO connectors and index-matching films of the prior art.

It is an object of the present invention to provide an improved frame for aligning a lens set attached to the frame to the fiber ends of a ferrule of an MPO connector at a location between the fiber ends and the lens.

It is an object of the present invention to provide an improved index-matching film frame for use with an MPO connector and/or an expanded beam MPO connector.

It is an object of the present invention to provide an expanded beam frame insert, which can be used to mate the fiber ends of two female MPO connectors.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front perspective view of a lens frame, in accordance with the present invention;

FIG. 2 is a rear perspective view of the lens frame of FIG. 1;

FIG. 3 is a front perspective view of the lens frame of FIGS. 1 and 2, with a sheet containing a plurality of lenses located inside of a window formed in a central region of the lens frame;

FIG. 4 is a front perspective view of the lens frame of FIG. 3 in combination with a multi-fiber ferrule;

FIG. 5 is a front perspective view of the multi-fiber ferrule of FIG. 4 with the lens frame removed therefrom;

FIG. 6 is a perspective view of first and second fiber optic connectors, formed as depicted in FIG. 4, just prior to mating;

FIG. 7 is a front perspective view of an alignment frame holding a film slid over the lens frame of FIG. 3; and

FIG. 8 is a front perspective view of an expanded beam converter for mating two female MPO connectors.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y. As used herein, phrases such as from about X to Y” mean from about X to about Y.

It will be understood that when an element is referred to as being on, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

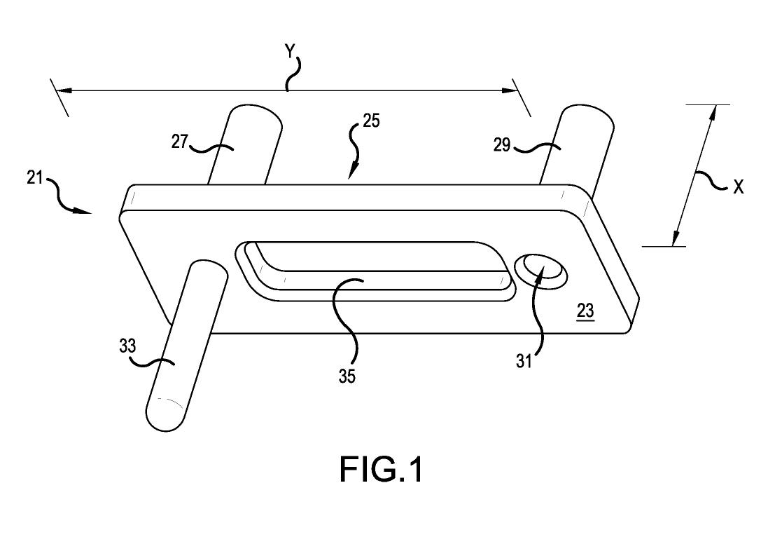

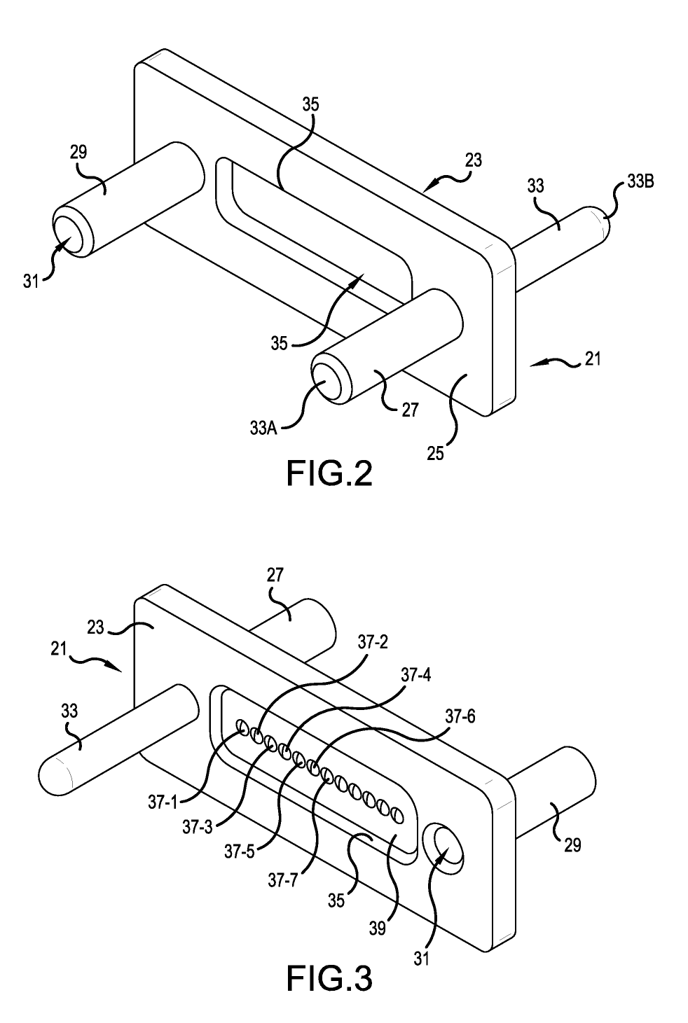

FIG. 1 is a front perspective view of a lens frame 21 and FIG. 2 is a rear perspective view of the lens frame 21, in accordance with the present invention. The lens frame 21 includes a front surface 23 and a back surface 25, wherein the front surface 23 is opposite to the back surface 25. First and second alignment sleeves 27 and 29 extend from the back surface 25. In a preferred embodiment, the first and second alignment sleeves 27 and 29 extend at a ninety degree angle from the back surface 25, and extend a distance x, where x is approximately 25% to 50% of the width y of the lens frame 21.

The first and second alignment sleeves 27 and 29 may be formed as cylinders and be hollow in the central region 31. In a preferred embodiment, a first pin 33 is located and fixed within the first alignment sleeve 27. A back end 33A of the first pin 33 is located near an end of the first alignment sleeve 27 and a front end 33B of the first pin 33 extends out of the front surface 23 of the lens frame 21. Instead of the first pin 33 being fixed with the hollow central region 31 of the first alignment sleeve 27, the first pin 33 and first alignment sleeve 27 may be integrally formed as a single piece, e.g., a single metal element.

A plurality of lenses 37 are located inside a window 35, formed in a central region of the lens frame 21. In one embodiment, the plurality of lenses 37 are molded onto a lens sheet 39 and the lens sheet 39 is fused, e.g., by a heating and pressing process, into the window 35 formed in the lens frame 21. Of course, the molding and fusing processes may be accomplish in one common step. In one embodiment, the lens sheet 39 is fused into the window 35 in a position such that the lenses 37 are recessed into the window 35 and no part of the lenses 37 protrudes past a plane of the front surface 23 of the lens frame 21, as best seen in FIG. 3. The lens frame 21 need not be formed of an optical grade material. The lens frame 21 may be formed of metal or ceramic, such as kovar, steel, invar or similar materials.

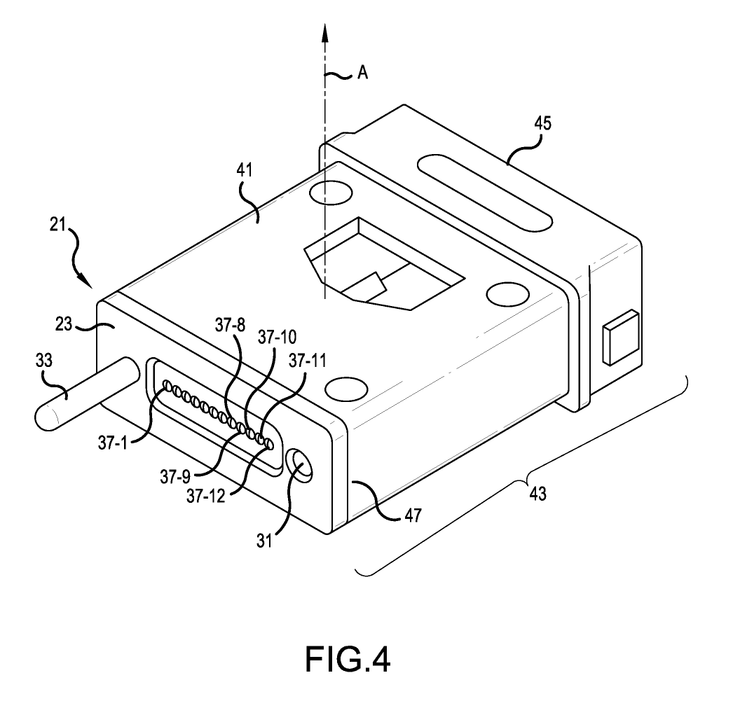

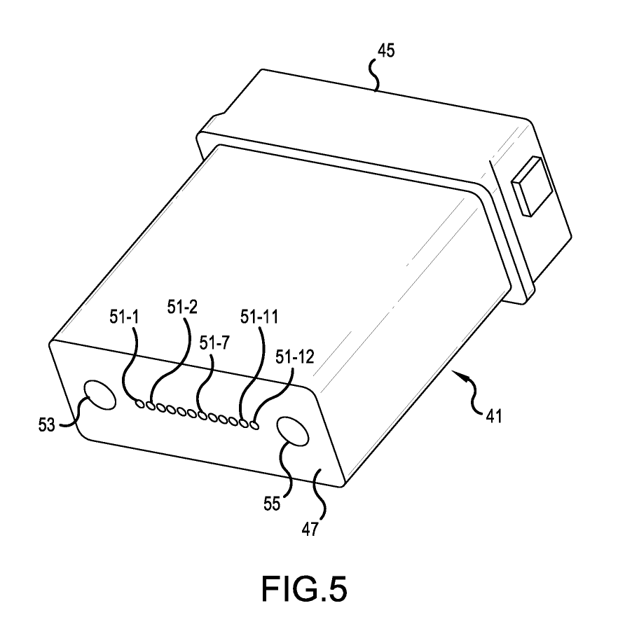

FIG. 4 is a front perspective view of the lens frame 21 of FIGS. 1-3 in combination with a multi-fiber ferrule 41, such as commonly employed in MTP/MPO or MT-RJ connectors. FIG. 4 shows the formation of an expanded beam multi-channel fiber optic connector 43, in accordance with the present invention. The ferrule 41 of the fiber optic connector 43 holds a plurality of optical fibers (see fiber ends 51-1 through 51-12 in FIG. 5). The ferrule 41 has a first end 45 and a second end 47, wherein the second end 47 is opposite to the first end 45, and the second end 47 is considered a mating face.

A plurality of optical fibers enter at the first end 45 of the ferrule 41 and extend to the second end 47 of the ferrule 41 in an array or ribbon format. The ends 51-1 through 51-12 of the plurality of optical fibers are approximately flush or slightly protruding along the mating face 47 of the ferrule 41.

As illustrated in FIG. 4, the lens frame 21 has its back surface 25 abutting the mating face 47 of the ferrule 41. The plurality of lenses 37-1 through 37-12 formed in the lens frame 21 overlie the plurality of fiber ends 51-1 through 51-12, wherein each lens (e.g., lens 37-1) of the plurality of lenses 37 overlies a flush or protruding fiber end (e.g., fiber end 51-1) of one of the plurality of optical fiber ends 51.

In a preferred embodiment, the lens frame 21 is removably attached to the ferrule 41. The mating face 47 of the ferrule 41 has first and second holes 53 and 55 extending from the mating face 47 into the ferrule 41. The first and second alignment sleeves 27 and 29 sleeves are pressed into the first and second holes 53 and 55 until the back surface 25 of the lens frame 21 abuts the mating face 47 of the ferrule 41. The lens frame 21 is then held in engagement with the ferrule 41 by the frictional engagement of the first and second alignment sleeves 27 and 29 within the first and second holes 53 and 55. Of course, an epoxy may be applied if a more permanent attachment is desired.

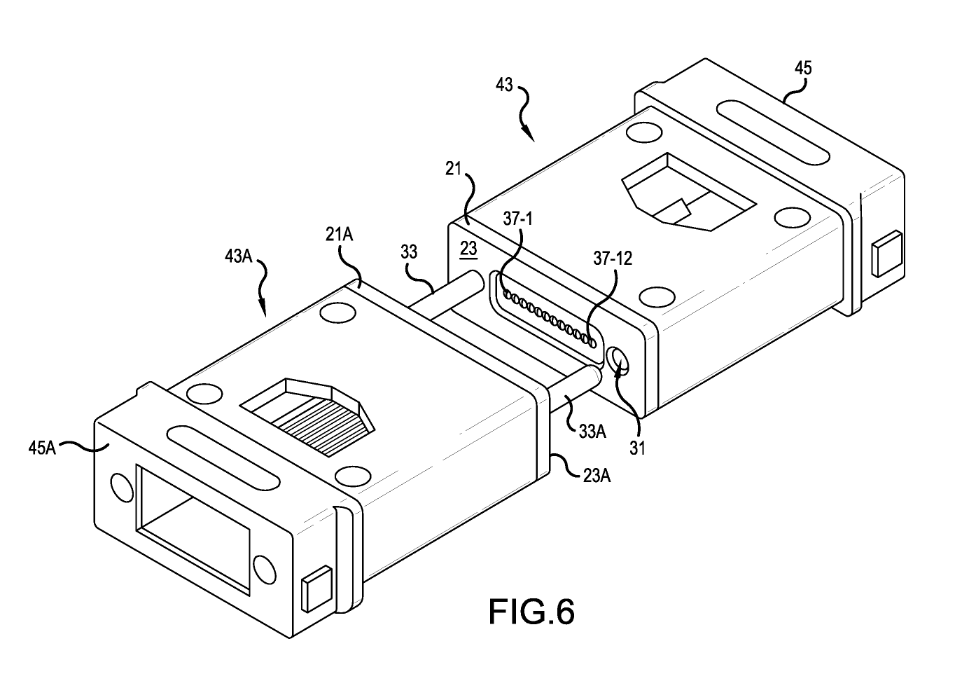

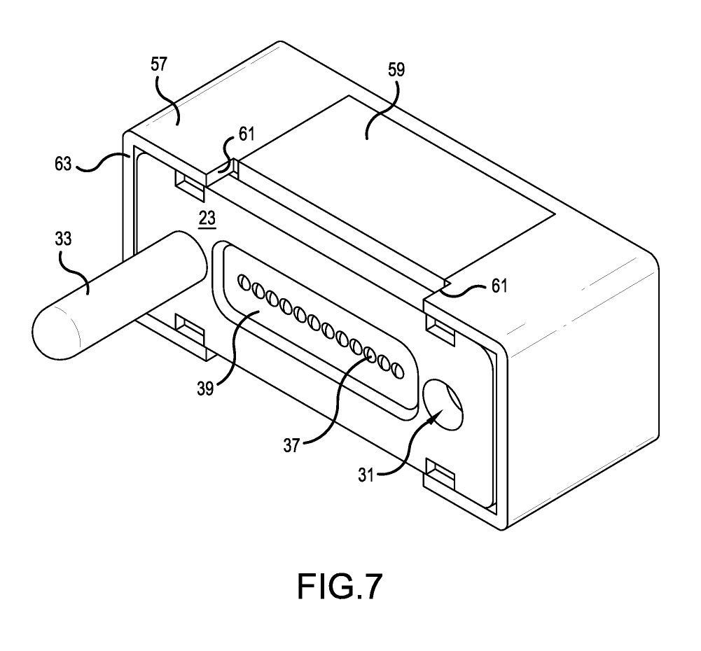

FIG. 6 is a perspective view of the fiber optic connector 43, now referred to as a first fiber optic connector 43, and a second fiber optic connector 43A. The second fiber optic connector 43A is identical to the first fiber optic connector 43, but is rotated one hundred eighty degrees about axis A in FIG. 4. The first pin 33 of the first fiber optic connector 43 is inserted into the hollow central region 31A of the second alignment sleeve 29A of the second fiber optic connector 43A. The first pin 33A of the second fiber optic connector 43A is inserted into the hollow central region 31 of the second alignment sleeve 29 of the first fiber optic connector 43. By the second alignment sleeves 29/29A being hollow and accepting the pins 33A/33 associated with lens frames 21A/21 of the second and first fiber optic connectors 43A/43, the front surface 23A of the second fiber optic connector 43A may be brought into contact with the front surface 23 of the first fiber optic connector 43, so that the two lens sets 37A and 37 closely face to each other.

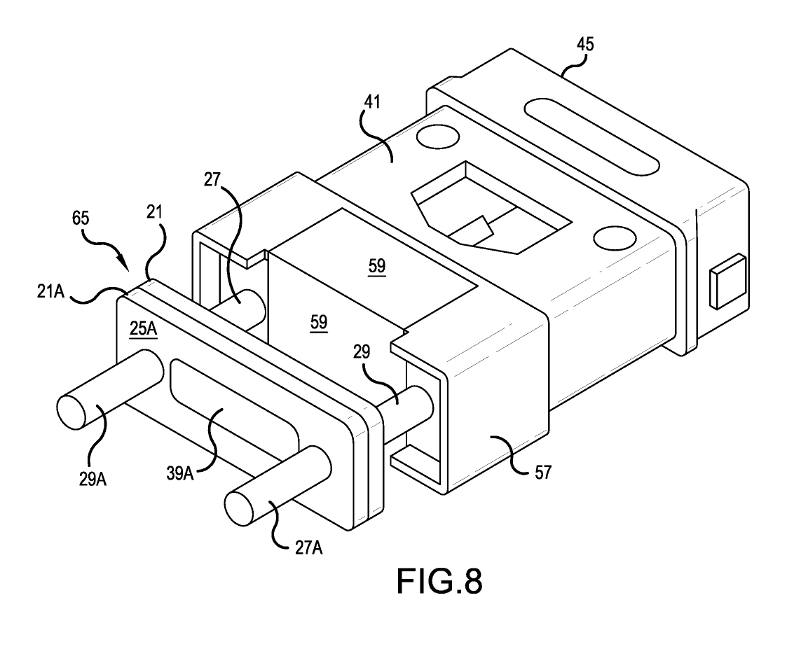

In a non-expanded beam connector, the ends 51 of the optical fibers are typically polished in a multistep process, as previously outlined in the discussion of the background art. With an expanded beam connector, in accordance with the present invention, it may be possible to eliminate several, it not all of the polishing steps. In other words, the fiber ends 51 may be cleaved and unpolished. This advantageous feature is best understood with reference to FIG. 7.

FIG. 7 shows an alignment frame 57 holding a film 59. The structure and advantages of the alignment frame 57 and film 59 are described in the text and drawings, e.g., FIG. 46, of US Published Application No. 2007/0086707, the entire contents of which are incorporated herein by reference.

The alignment frame 57 is slid over the first end 47 of the ferrule 41, so that the film 59 covers the fiber ends 51. Next, the lens frame 21 is installed onto the mating face 47 of the ferrule 41, as discussed above. In a preferred embodiment, the lens frame 21 sits inside the a front lip 61 of the alignment frame 57, so that the front surface 23 of the lens frame 21 is approximately flush with a front edge 63 of the alignment frame 57. In one embodiment, the lens frame 21 is attached to the alignment frame 57 at the factory, so that the two frames 21 and 57, as a unit, are installed onto the first end 47 of the ferrule 41 by a technician in the field.

Once the lens frame 21 is installed on the ferrule 41, the film 59 is disposed between the fiber ends 51 of the plurality of optical fibers and the plurality of lenses 37. The film 59 is compliant to accommodate fiber ends 51 protruding in an uneven manner from the mating face 47 of the ferrule 41. Hence, the film 59 provides an advantage in that it may be possible to leave the fiber ends 51 in an uneven state and skip some or all of the polishing steps for the fiber ends 51. This is very advantageous when conducting a field termination with a multi-fiber ferrule.

FIG. 8 is a perspective view of an expanded beam converter 65 for mating two female MPO connectors. The converter 65 is essentially two lens frames 21 and 21A, as depicted in FIG. 3, with the front surfaces 23 thereof being fused or connected, so that the lens 37 and 37A of each lens frame 21 and 21A face to each other.

More specifically, the first lens frame 21 includes the front surface 23 and the back surface 25, wherein the front surface 23 is opposite to the back surface 25. First and second alignment sleeves 27 and 29 extend from the back surface 25 of the first lens frame 21. Lenses 37 are formed in the first lens frame 21. A second lens frame 21A includes a front surface 23A and a back surface 25A, wherein the front surface 23A is opposite to the back surface 25A. First and second alignment sleeves 27A and 29A extend from the back surface 25A of the second lens frame 21A. Lenses 37A are formed in the second lens frame 21A. The front surface 23 of the first lens frame 21 abuts the front surface 23A of the second lens frame 21A, and the lenses 37 formed in the first lens frame 21 are aligned to the lenses 37A formed in the second lens frame 21A.

In use, the first and second alignment sleeves 27 and 29 extending from the back surface 25 of the first lens frame 21 are dimensions to fit into first and second holes 53 and 55 formed in a mating face 47 of a first female MPO connector 41. Likewise, the first and second alignment sleeves 27A and 29A extending from the back surface 25A of the second lens frame 21A are dimensions to fit into first and second holes 53A and 55A formed in a mating face 47A of a second female MPO connector 41A, so that fiber ends 51 presented by the first female MPO connector 41 are brought into communication with fiber ends 51A presented by the second female MPO connector 41A via the aligned plurality of lenses 37 and 37A formed in the first and second lens frames 21 and 21A.

Although the figures of this application have illustrated the lenses 37 as all having a same shape and size, the lenses may have different prescriptions, as detailed in the Assignee's published US Patent application 2015/0104135, which is herein incorporated by reference. For example, the plurality of lens 37 may include a first set of lenses (e.g., 37-1, 37-3, 37-5, . . . ) of a first prescription optimized to receive light from a fiber end and transmit light away from the lens, and the plurality of lens 37 may include a second set of lenses (e.g., 37-2, 37-4, 37-6, . . . ) of a second prescription optimized to receive light into the lens and focus light onto a fiber end.

The lens frame 21 may be formed of kovar, steel, invar, or a polymer impregnated with a material to provide strength and reduce the coefficient of thermal expansion of the lens frame 21. The lens 37 and lens sheet 39 may be formed of fused silica, fused quartz, sapphire, silicon, other optical glasses or optical grade polymers.

The present invention also encompasses a method of forming an expanded beam fiber optic array connector comprising: inserting a plurality of optical fibers into a first end of a ferrule until ends of the plurality of optical fibers are approximately flush with or slightly protruding from a second end of the ferrule. Cleaving, but not polishing, the ends of the plurality of optical fibers at the second end of the ferrule. Abutting a lens frame over the cleaved ends of the plurality of optical fibers. Aligning lenses within the lens frame with the polished ends of the plurality of optical fibers, and attaching the lens frame to the ferrule. The attaching the lens frame to the ferrule step may be accomplished by frictionally engaging one or more alignment sleeves affixed to the lens frame within holes formed in the second end of the ferrule.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A fiber optic connector device comprising:
a ferrule for holding a plurality of optical fibers, said ferrule having a first end and a second end, wherein said second end is opposite to said first end;
a plurality of optical fibers entering at said first end of said ferrule and extending to said second end of said ferrule, wherein ends of said plurality of optical fibers are approximately flush or slightly protruding along a mating face defining said second end of said ferrule;
a lens frame having a front surface and a back surface, wherein said back surface abuts said second end of said ferrule, and wherein said front surface is opposite to said back surface; and
a plurality of lenses formed in said lens frame, wherein each lens of said plurality of lenses overlies a flush or protruding end of one of said plurality of optical fibers.

2. The device of claim 1, wherein said lens frame is removably attached to said ferrule.

3. The device of claim 1, wherein said second end of said ferrule has first and second holes extending from said mating face into said ferrule, and wherein said lens frame has first and second alignment sleeves extending from said back surface into said first and second holes when said back surface of lens frame abuts said mating face of said ferrule.

4. The device of claim 1, wherein said first alignment sleeve includes a first pin which extends out of said front surface of said lens frame.

5. The device of claim 4, wherein said second alignment sleeve is hollow, and may accept a second pin associated with another fiber optic connector.

6. The device of claim 1, wherein said ends of said plurality of optical fibers are cleaved and unpolished.

7. The device of claim 6, further comprising:
a film disposed between said ends of said plurality of optical fibers and said plurality of lenses.

8. The device of claim 7, wherein said film is attached to an alignment frame, and wherein said alignment frame seats on said ferrule to place said film over said ends of said plurality of optical fibers on said mating face of said ferrule.

9. The device of claim 1, wherein said plurality of lenses are molded and fused into said lens frame.

10. The device of claim 1, wherein said plurality of lenses are molded onto a sheet and said sheet is fused into a window formed in said lens frame.

11. A lens frame device comprising:
a front surface and a back surface, wherein said front surface is opposite to said back surface;
first and second alignment sleeves extending from said back surface;
a first pin within said first alignment sleeve, which extends out of said front surface of said lens frame; and
a plurality of lenses formed in said lens frame.

12. The device of claim 11, wherein said second alignment sleeve is hollow, and may accept a second pin associated with another lens frame.

13. The device of claim 11, wherein said plurality of lenses are molded and fused into said lens frame.

14. The device of claim 11, wherein said plurality of lenses are molded onto a sheet and said sheet is fused into a window formed in said lens frame.

15. The device of claim 14, wherein said lens frame is formed of a different material than a material used to form said sheet.

16. The device of claim 14, wherein said lens frame is formed of kovar, steel, invar or a polymer impregnated with a material to provide strength.

17. The device according of claim 11, wherein said plurality of lens includes lenses of different prescriptions, and wherein said plurality of lens includes a first set of lenses of a first prescription optimized to receive light from a fiber end and transmit light away from the lens and a second set of lenses of a second prescription optimized to receive light into the lens and focus light onto a fiber end.

18. An expanded beam converter device for mating two female MPO connectors, said converter comprising:
a first lens frame including:
a front surface and a back surface, wherein said front surface is opposite to said back surface;
first and second alignment sleeves extending from said back surface;
a plurality of lenses formed in said first lens frame; and
a second lens frame including:
a front surface and a back surface, wherein said front surface is opposite to said back surface;
first and second alignment sleeves extending from said back surface;
a plurality of lenses formed in said second lens frame; and
wherein said front surface of said first lens frame abuts said front surface of said second lens frame and said plurality of lenses formed in said first lens frame are aligned to said plurality of lenses formed in said second lens frame.

19. The device of claim 18, wherein said first and second alignment sleeves extending from said back surface of said first lens frame are dimensions to fit into first and second holes formed in a mating face of a first female MPO connector, wherein said first and second alignment sleeves extending from said back surface of said second lens frame are dimensions to fit into first and second holes formed in a mating face of a second female MPO connector, so that fiber ends presented by said first female MPO connector are brought into communication with fiber ends presented by said second female MPO connector via the aligned plurality of lenses formed in said first and second lens frames.

20. A method of forming an expanded beam fiber optic array connector comprising:
inserting a plurality of optical fibers into a first end of a ferrule until ends of the plurality of optical fibers are approximately flush with or slightly protruding from a second end of the ferrule;
cleaving, but not polishing, the ends of the plurality of optical fibers at the second end of the ferrule;
abutting a lens frame over the cleaved ends of the plurality of optical fibers;
aligning lenses within the lens frame with the polished ends of the plurality of optical fibers; and
attaching the lens frame to the ferrule, wherein attaching the lens frame to the ferrule is accomplished by frictionally engaging one or more alignment sleeves affixed to the lens frame within holes formed in the second end of the ferrule.
